(19) United States
(12) Patent Application Publication
(10) Pub. No.: US 2010/0245623 A1
(43) Pub. Date: Sep. 30, 2010

(54) STILL IMAGE MEMORY DEVICE AND LIGHTING APPARATUS

(75) Inventors: Sayako KASAHARA, Kanagawa (JP); Hiroshi Sukegawa, Tokyo (JP)

Correspondence Address: POSZ LAW GROUP, PLC, 12040 SOUTH LAKES DRIVE, SUITE 101, RESTON, VA, 20191, US

(73) Assignee: KABUSHIKI KAISHA TOSHIBA

(21) Appl. No.: 12/722,132

(22) Filed: Mar. 11, 2010

(30) Foreign Application Priority Data
Mar. 24, 2009 (JP) 2009-071865

(51) Int. Cl. H04N 5/76

(52) U.S. Cl. 348/231.2; 348/231.99; 348/370; 348/E05.031

(57) ABSTRACT

A still image memory device includes an imaging unit, a nonvolatile memory unit that includes a first memory area and a second memory area, and a control unit that controls the nonvolatile memory unit. The control unit includes a first processing unit that stores, in the first memory area, the image data output from the imaging unit; a second processing unit that, based on memory status of the first memory area, reads and compresses image data selected from a plurality of image data stored in the first memory area, stores compressed image data in the second memory area, and destroys the image data selected from the plurality of image data stored in the first memory area; and a third processing unit that, based on memory status of the second memory area, destroys compressed image data selected from a plurality of compressed image data stored in the second memory area.

### CROSS-REFERENCE TO RELATED APPLICATIONS

This application is based upon and claims the benefit of priority from the prior Japanese Patent Application No. 2009-071865, filed on Mar. 24, 2009; the entire contents of which are incorporated herein by reference.

### BACKGROUND OF THE INVENTION

1. Field of the Invention

The present invention relates to a still image memory device and a lighting apparatus.

2. Description of the Related Art

As a technology for efficiently storing still images in a memory, Japanese Patent Application Laid-open No. 2001-218165 discloses a digital signal memory device that is configured to store at least input image signals and that includes an image processing unit for performing an encoding operation of the input image signals and a memory unit for temporarily storing digital signals while the image processing unit is performing the encoding operation. In the digital signal memory device, the memory unit is segmented into at least an area that is used in moving-image processing and an area other than the area used for moving-image processing that is entirely used for still-image processing.

However, in the technology disclosed in Japanese Patent Application Laid-open No. 2001-218165, the memory unit is used to only temporarily store the digital signals. Besides, no consideration is given to the manner in which the area for still-image processing is to be used. Thus, reliability is not ensured regarding storing of the still images.

### BRIEF SUMMARY OF THE INVENTION

A still image memory device according to an embodiment of the present invention comprises: an imaging unit that captures an image and outputs image data obtained by capturing the image; a nonvolatile memory unit that includes a first memory area and a second memory area; and a control unit that controls the nonvolatile memory unit, the control unit including a first processing unit that stores, in the first memory area, the image data output from the imaging unit; a second processing unit that, based on memory status of the first memory area, reads and compresses image data that is selected from a plurality of image data stored in the first memory area, stores compressed image data in the second memory area, and destroys the image data that is selected from the plurality of image data stored in the first memory area; and a third processing unit that, based on memory status of the second memory area, destroys compressed image data that is selected from a plurality of compressed image data stored in the second memory area.

### BRIEF DESCRIPTION OF THE DRAWINGS

FIG. 1 is a block diagram of a configuration of a still image memory device according to a first embodiment of the present invention;

FIG. 2 is a schematic diagram of exemplary image data captured by an imaging unit;

FIG. 3 is a schematic diagram of exemplary image data stored in a nonvolatile memory;

FIG. 4 is a schematic diagram of an exemplary system for performing authentication of the still image memory device;

FIG. 5 is a schematic diagram of a circuit configuration of a lighting apparatus according to a second embodiment of the present invention; and

FIG. 6 is a schematic diagram of an exemplary arrangement of the still image memory device and a light-emitting diode (LED) unit in the lighting apparatus.

### DETAILED DESCRIPTION OF THE INVENTION

Exemplary embodiments of a still image memory device and a lighting apparatus according to the present invention will be explained below in detail with reference to the accompanying drawings. The present invention is not limited to the following embodiments.

### First Embodiment

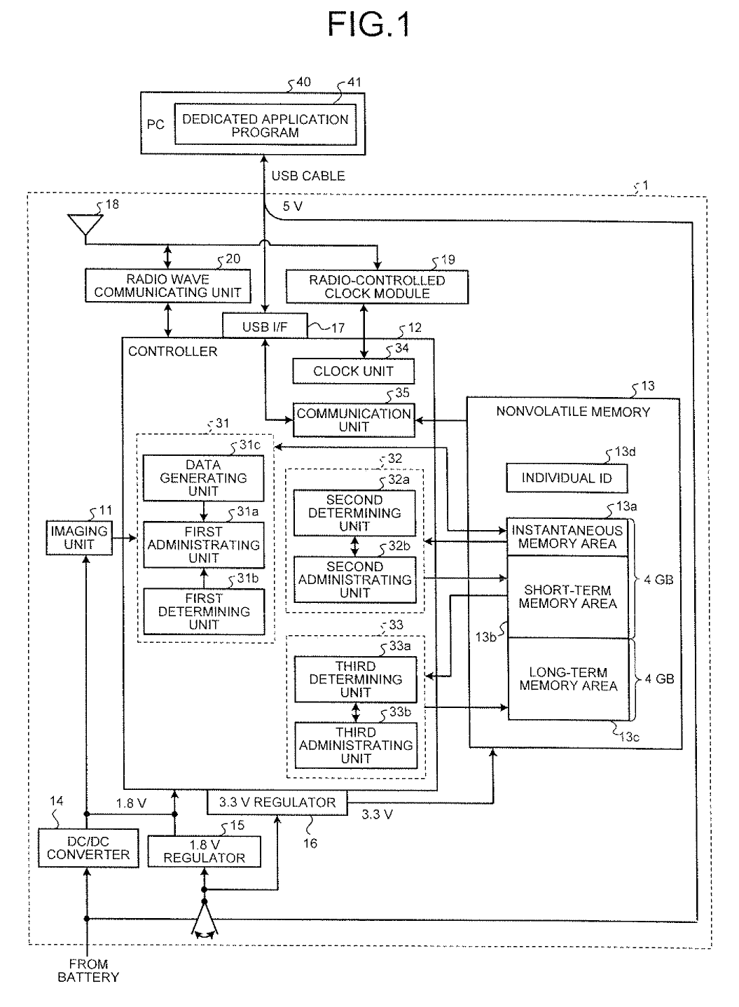

FIG. 1 is a block diagram of a configuration of a still image memory device according to a first embodiment of the present invention. A still image memory device 1 can also be used as, for example, a security camera. In the case of conventional security cameras, the system designing is done on the basis of a basic usage pattern in which a surveillance agent monitors the images captured by security cameras at a distant location from the installation sites of the security cameras. With the purpose of reducing the number of surveillance agents or increasing the memory functions, the captured images are generally stored in a magnetic tape or a hard disk drive (HDD). Herein, since laying of image signal cables or power cables causes expenses, the number of installation sites of the security cameras or the number of security cameras is restricted from the perspective of expenses. Besides, since the captured images are transmitted via image signal cables, the resolution of the images cannot be increased freely. Consequently, the images having low resolution provide less evidential capacity thereby resulting in poorer deterrence against crime. In contrast, in the still image memory device 1, the abovementioned concept of image monitoring by a surveillance agent is eliminated. Instead, the function of storing image data is enhanced so that the still image memory device 1 can operate as a standalone device at the corresponding installation site. In addition, the still image memory device 1 is equipped with functions for ensuring reliability, storing only the useful information, securing evidential capacity equivalent to a witness, and preventing misuse such as theft. Meanwhile, the still image memory device 1 having a high resolution can be linked in plurality by a system and installed at multiple sites so that it becomes possible to achieve a greater crime prevention effect.

As illustrated in FIG. 1, the still image memory device 1 includes an imaging unit 11 that can be configured from a two-million-pixel complementary metal-oxide semiconductor (CMOS) camera or the like, a controller 12 that can be configured from a single chip microcomputer or the like, a nonvolatile memory 13 that can be configured from a NAND-type memory device or the like, a DC/DC converter 14, a first regulator 15 (e.g., a 1.8 V regulator), a second regulator (e.g., a 3.3 V regulator), a universal serial bus (USB) interface 17, an antenna 18, a radio-controlled clock module 19, and a radio wave communicating unit 20. The imaging unit 11 and the controller 12 are interconnected via a control bus such as a 12C bus and a data bus.

The controller 12 corresponds to a control unit. The nonvolatile memory 13 corresponds to a nonvolatile memory unit. The DC/DC convertor 14 and the 3.3 V regulator 16 correspond to a first power supplying unit. The 1.8 V regulator 15 and the 3.3 V regulator 16 correspond to a second power supplying unit. The first power supplying unit and the second power supplying unit correspond to a power supplying unit.

The still image memory device 1 can operate on a battery (e.g., a lithium ion battery (3.7 V) or a dry-cell battery (3.0 V)) or a USB bus power (5.0 V) as the source of electrical energy. When a battery is used as the source of electrical energy, the DC/DC converter 14 converts the voltage of the battery into a desired first voltage (e.g., 1.8 V) and supplies the first voltage to the imaging unit 11 and the controller 12; while the 3.3 V regulator 16 converts the voltage of the battery into a desired second voltage (e.g., 3.3 V) and supplies the second voltage to the nonvolatile memory 13. When a USB bus power is used as the source of electrical energy, the 1.8 V regulator 15 converts the voltage of the USE bus power into a desired first voltage (e.g., 1.8 V) and supplies that voltage to the imaging unit 11 and the controller 12; while the 3.3 V regulator 16 converts the voltage of the USE bus power into the desired second voltage (e.g., 3.3 V) and supplies the second voltage to the nonvolatile memory 13. Meanwhile, it is also possible to dispose a power supplying unit that converts an alternating-current (AC) voltage to a desired voltage. That makes it possible to secure the supply of AC voltage from outside.

The controller 12 includes a first processing unit 31, a second processing unit 32, a third processing unit 33, a clock unit 34, and a communication unit 35. The first processing unit 31, the second processing unit 32, the third processing unit 33, and the communication unit 35 can be implemented when a central processing unit (CPU) executes programs stored in a read only memory (ROM). The clock unit 34 can be implemented using a real time clock (RTC).

The first processing unit 31 includes a first administrating unit 31a, a first determining unit 31b, and a data generating unit 31c.

The second processing unit 32 includes a second determining unit 32a and a second administrating unit 32b. The third processing unit 33 includes a third determining unit 33a and a third administrating unit 33b.

In the nonvolatile memory 13, about half (e.g., about 4 GB) of the total memory area (e.g., about 8 GB) is assumed to be a first memory area of the memory capacity and the remaining half (e.g., about 4 GB) of the total memory area (e.g., about 8 GB) is assumed to be a second memory area of the memory capacity. The first memory area includes an instantaneous memory area 13a and a short-term memory area 13b. The instantaneous memory area 13a can be configured to perform high-speed two-value storing of image data of a single or a plurality of images. Moreover, instead of a nonvolatile memory, the instantaneous memory area 13a can be partially or entirely allotted to be a volatile memory such as a dynamic random access memory (DRAM) or a static random access memory (SRAM). The short-term memory area 13b can be configured to perform multi-value storing of uncompressed image data of about 1000 images. The second memory area includes a long-term memory area 13c that can be configured to perform multi-value storing of compressed image data of about 5000 images compressed to about ⅕-th of the original image size. In this way, the first memory area, which is about the half of the total memory area of the nonvolatile memory 13, is used for storing uncompressed image data; while the second memory area, which is about the half of the total memory area of the nonvolatile memory 13, is used for storing compressed image data. Thus, even if a bit error that is not correctable using an error correcting code (ECC) occurs in the image data stored in the first memory area, it becomes possible to strike a balance between holding the deterioration in the image data only to a partial defect and storing long-term image data in the second memory area. Meanwhile, the proportion of the first memory area and the second memory area can be allowed to be changed at the time of factory shipment or by the end user using a parameter. In that case, the parameter can be set from a personal computer (PC) 40. Moreover, as the nonvolatile memory 13, it is possible to use, for example, a NAND-type flash memory.

Given below is the description about the operations performed by the still image memory device 1. The still image memory device 1 transits between a low power consumption mode (e.g., quiescent mode, sleep mode) and a normal mode (operating mode). At desired timings, the controller 12 causes the transition from the low power consumption mode to the normal mode, instructs the imaging unit 11 to perform imaging, and again causes the transition to the low power consumption mode. The desired timings can be desired time intervals (e.g., time intervals of 0.5 second) or can be timings at which trigger signals are received from outside via the antenna 18 and the radio wave communicating unit 20. The timekeeping of the desired time intervals can be performed with the clock unit 34. The timings obtained by the clock unit 34 are corrected based on long-wave standard waves received by the antenna 18 and the radio-controlled clock module 19.

The first administrating unit 31a stores the image data (that can be YUV data, RGB data, or data in another color coordinate system) output from the imaging unit 11 in the instantaneous memory area 13a. The first determining unit 31b compares the most recently captured image data with the previously captured image data captured by the imaging unit 11 and determines whether the comparative difference therebetween is equal to or more than a predetermined amount. If the first determining unit 31b determines that the comparative difference between the most recently captured image data and the previously captured image data captured by the imaging unit 11 is equal to or more than a predetermined amount, then the first administrating unit 31a can be configured to store the image data output from the imaging unit 11 in the first memory area. As a result, it becomes possible to store only the image data corresponding to changes occurring in the images (e.g., a human being or a physical body moving within the imaging range). Since it can be assumed that the image data including images with some changes is more useful than the image data including images without any changes, it becomes possible to store only the useful image data. Meanwhile, if the first determining unit 31.b determines that the comparative difference between the most recently captured image data and the previously captured image data captured by the imaging unit 11 is equal to or more than a predetermined amount, then the first administrating unit 31a can also be configured to store a plurality of image data output from the imaging unit 11 for a predetermined time period since the time of determination performed by the first determining unit 31b.

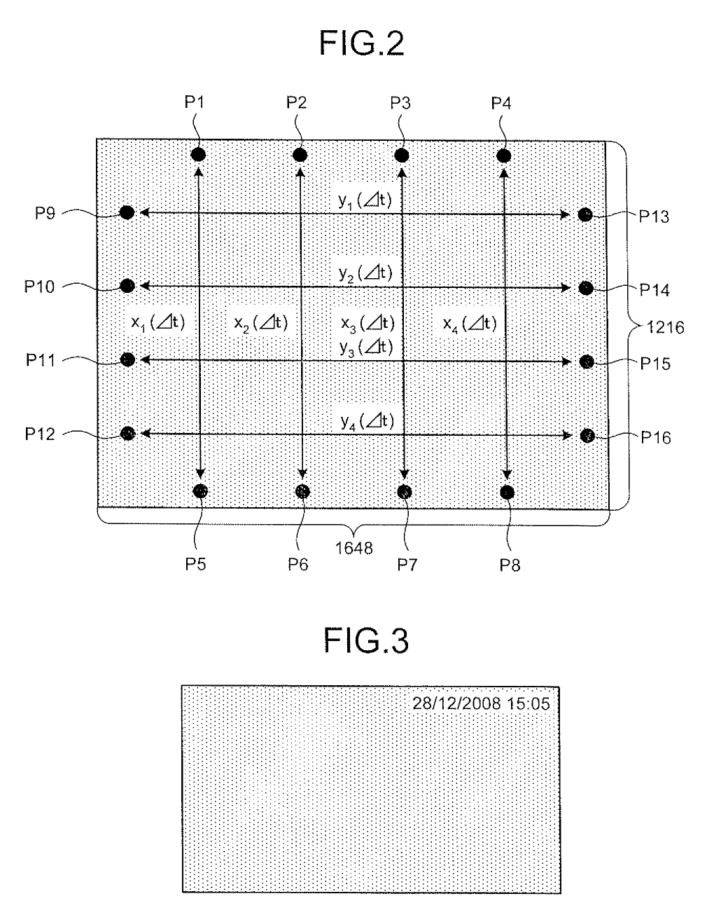

Following is an example of the method for comparing the most recently captured image data and the previously captured image data captured by the imaging unit 11. For example, as illustrated in FIG. 2, the first determining unit 31b extracts pixels P1 to P4 at the top, pixels P5 to P8 at the bottom, pixels P9 to P12 on the left side, and pixels P13 to P16 on the right side. Then, as the differences between the values of two different pixels of image data, the first determining unit 31b calculates a difference x1(Δt) between the value of the pixel P1 (corresponding to a single component or all components of YUV components or RGB components) and the value of the pixel P5; a difference x2(Δt) between the value of the pixel P2 and the value of the pixel P6; a difference x3(Δt) between the value of the pixel P3 and the value of the pixel P7; a difference x4(Δt) between the value of the pixel P4 and the value of the pixel P8; a difference y1(Δt) between the value of the pixel P9 and the value of the pixel P13; a difference y2(Δt) between the value of the pixel P10 and the value of the pixel P14; a difference y3(Δt) between the value of the pixel P11 and the value of the pixel P15; and a difference y4(Δt) between the value of the pixel P12 and the value of the pixel P16. Subsequently, the differences x1(Δt), x2(Δt), x3(Δt), x4(Δt), y1(Δt), y2(Δt), y3(Δt), and y4(Δt) can be compared respectively with differences x1(Δ(t−1)), x2(Δ(t−1)), x3(Δ(t−1)), x4(Δ(t−1)), y1(Δ(t−1)), y2(Δ(t−1)), y3(Δ(t−1)), and y4(Δ(t−1)) in the previously captured image data. Alternatively, a calculation value ABS(x1(Δt))+ABS(x2(Δt))+ABS(x3(Δt))+ABS(x4(Δt))+ABS(y1(Δt))+ABS(y2(Δt))+ABS(y3(Δt))+ABS(y4(Δt)) can be calculated with respect to the most recently captured image data and then compared with an identical calculation value calculated with respect to the previously captured image data.

Returning to the explanation with reference to FIG. 1, the data generating unit 31c generates data that is used as an index (hereinafter also referred to as “index data”) while searching the image data captured by the imaging unit 11. The first administrating unit 31a can be configured to store, in the instantaneous memory area 13a, the index data generated by the data generating unit 31c along with the image data output from the imaging unit 11. As the index data, the data generating unit 31c can generate, for example, the average values of YUV or RGB components across the entire image data, area size of the area exceeding predetermined threshold values of the YUV or RGB components, or the average values of the YUV components or the RGB components within that area. Alternatively, it is also possible to consider the amount of change, such as the comparative difference, between the most recently captured image data and the previously captured image data as the index data. That enables achieving efficiency while performing a rough search of the image data. Meanwhile, the first administrating unit 31a can also be configured to store, in the instantaneous memory area 13a, time information obtained by the clock unit 34 as an attachment to the image data output from the imaging unit 11. Alternatively, as illustrated in FIG. 3, the first administrating unit 31a can embed a plurality of pixel data representing time (image data representing time) in the image data and store the image data in the instantaneous memory area 13a. That enables achieving enhancement in the evidential capacity and efficiency while performing a rough search of the image data.

Returning to the explanation with reference to FIG. 1, based on the memory status of the first memory area, the second processing unit 32 reads the selected image data that is selected from the plurality of image data stored in the first memory area, compresses the read image data, stores the compressed image data in the second memory area, and destroys the selected image data from the image data stored in the first memory area. More specifically, the second determining unit 32a determines whether the instantaneous memory area 13a has sufficient empty area to store therein the image data output from the imaging unit 11. If the second determining unit 32a determines that the instantaneous memory area 13a does not have sufficient empty area to store therein the image data output from the imaging unit 11, then the second administrating unit 32b reads the selected image data that is selected from among a single or a plurality of image data stored in the instantaneous memory area 13a and stores the read image data in the short-term memory area 13b. Then, the second administrating unit 32b destroys the selected image data from a single or a plurality of image data stored in the instantaneous memory area 13a and makes empty area available in the instantaneous memory area 13a. As far as the selection of image data from a single or a plurality of image data stored in the instantaneous memory area 13a is concerned, it is possible to select old image data, the oldest image data, or image data in the area that needs to be made available as empty area.

Then, the second determining unit 32a determines whether the short-term memory area 13b has sufficient empty area to store therein the selected image data that is selected from among a single or a plurality of image data stored in the instantaneous memory area 13a. If the second determining unit 32a determines that the short-term memory area 13b does not have sufficient empty area to store therein the selected image data that is selected from among a single or a plurality of image data stored in the instantaneous memory area 13a, then the second administrating unit 32b reads the selected image data that is selected from among a plurality of image data stored in the short-term memory area 13b, compresses the read image data, and stores the compressed image data in the long-term memory area 13c. Then, the second administrating unit 32b destroys the selected image data from a plurality of image data stored in the short-term memory area 13b and makes empty area available in the short-term memory area 13b. As far as the selection of image data from a plurality of image data stored in the short-term memory area 13b is concerned, it is possible to select old image data, the oldest image data, or image data in the area that needs to be made available as empty area.

Based on the memory status of the second memory area, the third processing unit 33 destroys the selected compressed image data that is selected from the plurality of compressed image data stored in the second memory area. More specifically, the third determining unit 33a determines whether the long-term memory area 13c has sufficient empty area to store therein the selected image data that is selected from among a plurality of image data stored in the short-term memory area 13b. If the third determining unit 33a determines that the long-term memory area 13c does not have sufficient empty area to store therein the selected image data that is selected from among a plurality of image data stored in the short-term memory area 13b, then the third administrating unit 33b destroys the selected compressed image data that is selected from among a plurality of compressed image data stored in the long-term memory area 13c and makes empty area available in the long-term memory area 13c. As far as the selection of image data from a plurality of compressed image data stored in the long-term memory area 13c is concerned, it is possible to select old compressed image data, the oldest compressed image data, or compressed image data in the area that needs to be made available as empty area.

Meanwhile, an upper limit for the number of images to be stored within a predetermined time period can be set using a parameter. As a result, for example, it becomes possible to set 48 hours as the time required to rewrite all image data in the still image memory device 1 (in other words, it is possible to retain the image data corresponding to the past 48 hours). The parameter can be allowed to be set from the PC 40.

Given below is the description about the operations during reading of the image data from the still image memory device 1. Returning to the explanation with reference to FIG. 1, the USB interface 17 in the still image memory device 1 is connectable to the PC 40 via a USB cable. The USB interface 17 is used in performing lower-level layer communication with the PC 40, while the communication unit 35 is used in performing higher-level layer communication with the PC 40. When the still image memory device 1 is connected to the PC 40 by a USB cable, it becomes accessible as a read only device of the mass storage class from the PC 40. Consequently, the PC 40 cannot be used to delete the image data from the nonvolatile memory 13 or to write image in the nonvolatile memory 13.

When the communication unit 35 receives an image data read request from a dedicated application program 41 that is dedicated for the still image memory device 1 and executed in the PC 40, it sends to the dedicated application program 41 the image data of, for example, 2 GB or 4 GB as a single or a plurality of uniquely defined 2 GB files or 4 GB files, respectively. The uniquely defined files can be configured to be expandable, fragmentable, and browsable only by the dedicated application program 41. As a result, it can be ensured that no application program other than the dedicated application program 41 can be used to expand, fragment, and browse the image data of the still image memory device 1. Meanwhile, the dedicated application program 41 can be configured to allow the input of a search condition (e.g., size or color of area (physical body, human being, etc.)). Moreover, the dedicated application program 41 can be configured to match a search condition and the index data attached to the image data and to display images that match with the search condition on a display screen (not illustrated) of the PC 40.

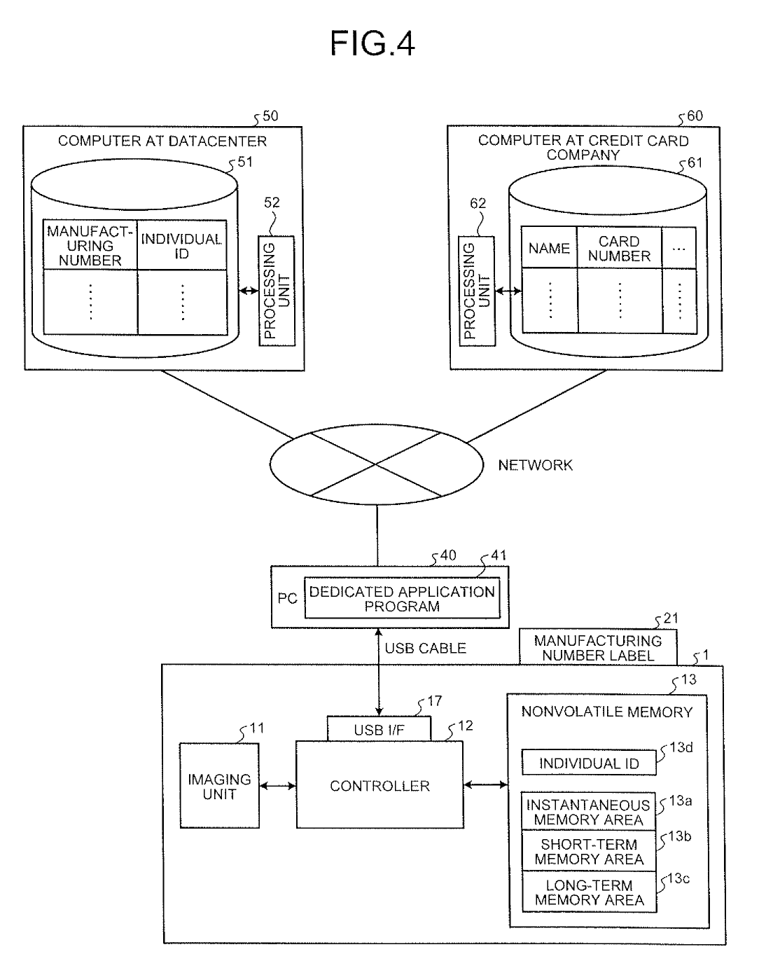

Meanwhile, from the perspective of preventing misuse such as theft, it is also possible to make authentication a must in order to allow the use of the still image memory device 1. FIG. 4 is a schematic diagram of an exemplary system for performing authentication of the still image memory device 1. The PC 40 that is connected to the still image memory device 1 via an USB cable is also connected to a computer 50 installed in a datacenter via a network such as LAN, WAN, Public Switched Telephone Network, and Internet.

At the manufacturing and shipping stage of the still image memory device 1, a manufacturing number and an individual ID are assigned thereto. The manufacturing number and the individual ID are stored in a memory unit 51 inside the computer 50 installed in the datacenter. The manufacturing number is mentioned, for example, on a manufacturing number label 21 pasted on the surface of the housing of the still image memory device 1 or in an instruction manual. That makes it possible for the end user to confirm the manufacturing number. In contrast, the individual ID is stored, for example, in an individual ID memory area 13d inside the nonvolatile memory 13 and is kept secret from the end user.

At the time of performing authentication of the still image memory device 1, the end user checks the manufacturing number mentioned on the manufacturing number label 21 and inputs the same in the dedicated application program 41 that is being executed in the PC 40. The dedicated application program 41 being executed in the PC 40 then reads the individual ID that is secretly stored in the individual ID memory area 13d inside the nonvolatile memory 13 and sends, to the computer 50 installed in the datacenter, the read individual ID and the manufacturing ID input by the end user. A processing unit 52 inside the computer 50 installed in the datacenter matches the individual ID and the manufacturing number that are received from the dedicated application program 41 being executed in the PC 40 with the individual ID and the manufacturing number that are assigned to the still image memory device 1 at the manufacturing and shipping stage and stored in the memory unit 51.

Meanwhile, it is also possible to charge a fee (e.g., 500 yen) in order to allow the use of the still image memory device 1. To pay the fee for using the still image memory device 1, the end user inputs information such as the credit card number in the dedicated application program 41 being executed in the PC 40. The dedicated application program 41 being executed in the PC 40 then sends the credit card number input by the end user to the computer 50 installed in the datacenter. The processing unit 52 inside the computer 50 installed in the datacenter makes an inquiry to a computer 60, which is installed in the credit card company and connected via a network, about the credit card number received from the dedicated application program 41 being executed in the PC 40. A memory unit 61 inside the computer 60 installed in the credit card company is used to store the name and the credit card number of the end user. Upon receiving an inquiry from the computer 50 installed in the datacenter, a processing unit 62 inside the computer 60 installed in the credit card company performs checking by referring to the memory unit 61 and sends the checking result to the computer 50 installed in the datacenter. Meanwhile, instead of allowing fee payment by credit card, it is also possible to allow electronic payment of the fee.

When the abovementioned authentication is complete, the processing unit 52 inside the computer 50 installed in the datacenter sends the information regarding authentication (that information can include the name of the authenticated end user) to the dedicated application program 41 being executed in the PC 40, which in turn writes the information regarding authentication in, for example, the nonvolatile memory 13 inside the still image memory device 1. Consequently, the still image memory device 1 becomes authenticated and operable. Meanwhile, alternatively, the information regarding authentication can be kept stored in the memory unit 51 inside the computer 50 installed in the datacenter and can be managed intensively in the computer 50 installed in the datacenter. In that case, the computer 50 installed in the datacenter can store the information regarding authentication in a corresponding manner with the manufacturing number and the individual ID.

Besides, from the perspective of preventing misuse such as theft, the still image memory device 1 can also be configured in the following manner: when the still image memory device 1 is operated or receives a trigger signal from outside, the radio wave communicating unit 20 and the antenna 18 (see FIG. 1) are made to transmit radio waves as a notification of the presence or operation of the still image memory device 1. Thus, by tracking the radio waves transmitted from the still image memory device 1, it becomes possible to know about the presence or operation thereof and prevent misuse such as theft. Alternatively, the still image memory device 1 can also be equipped with a sound generating unit or a light emitting unit that can emit sound or light when the still image memory device 1 is operated or receives a trigger signal from outside.

Meanwhile, from the perspective of implementing a system link function, the still image memory device 1 can be configured to perform imaging or image data storing when it receives a trigger signal from outside via the radio wave communicating unit 20 and the antenna 18. In that case, the still image memory device 1 can be configured to determine reception of the trigger signal at predetermined time intervals (e.g., time intervals of 0.5 second). For example, a security buzzer device that includes a radio wave transmitting unit for transmitting a trigger signal (radio waves) can be disposed and the still image memory device 1 can be configured to perform imaging or image data storing upon receiving the trigger signal from the security buzzer device. In that case, the security buzzer device can be configured to transmit the trigger signal for a sufficiently long period of time (e.g., for one second) that is longer than the time intervals (e.g., time intervals of 0.5 second) at which the still image memory device 1 determines reception of the trigger signal.

Moreover, the still image memory device 1 can also be configured to transmit a trigger signal via the radio wave communicating unit 20 and the antenna 18 (see FIG. 1) while performing imaging or image data storing. Because of that, for example, it becomes possible to dispose the still image memory device 1 in plurality and make them perform imaging or image data storing in tandem.

### Second Embodiment

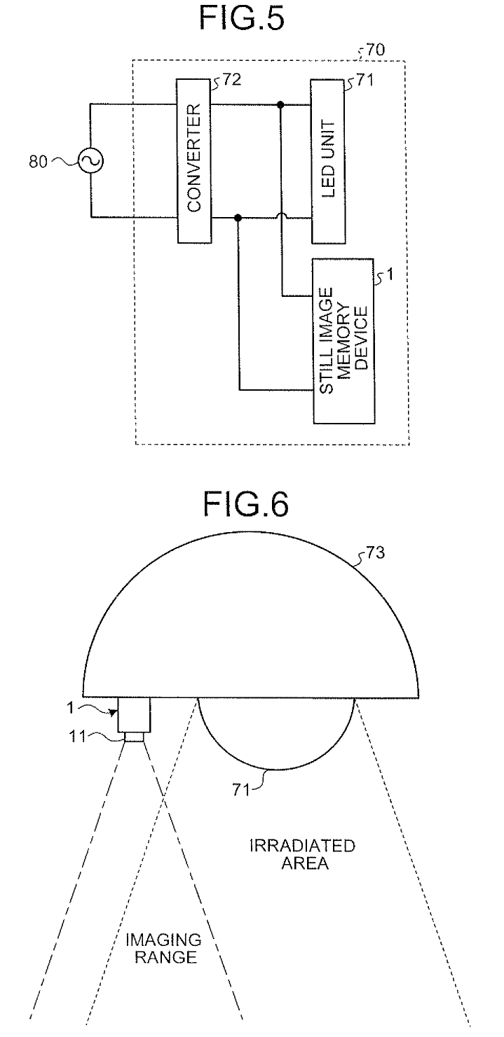

FIG. 5 is a schematic diagram of a circuit configuration of a lighting apparatus according to a second embodiment of the present invention. A lighting apparatus 70 includes the still image memory device 1, an LED unit 71, and a converter 72. The converter 72 converts an alternating-current (AC) voltage, which is input from an external power supply 80, into a direct-current (DC) voltage and supplies it to the still image memory device 1 and the LED unit 71. Thus, only one converter 72 is sufficient to drive the still image memory device 1 and the LED unit 71. Meanwhile, the external power supply 80 can itself be configured to be a DC power supply.

FIG. 6 is a schematic diagram of an exemplary arrangement of the still image memory device 1 and the LED unit 71 in the lighting apparatus 70. As illustrated in FIG. 6, the still image memory device 1 and the LED unit 71 are arranged within a shade portion 73 (that can be a reflector). Such a configuration makes it easier to dispose the still image memory device 1 and reduces the man-hours required to dispose the same.

The LED unit 71 emits light in the downward direction with reference to FIG. 6 and the imaging unit 11 in the still image memory device 1 captures images in the downward direction with reference to FIG. 6. It is desirable if the imaging range of the imaging unit 11 at least partially includes the area being irradiated by the light emitted from the LED unit 71. That makes it possible to capture clear images and enhance the evidential capacity.

According to an aspect of the present invention, reliability is ensured regarding storing of still images.

According to another aspect of the present invention, reliability is ensured regarding storing of still images that at least partially include the area being irradiated by light.

Additional advantages and modifications will readily occur to those skilled in the art. Therefore, the invention in its broader aspects is not limited to the specific details and representative embodiments shown and described herein. Accordingly, various modifications may be made without departing from the spirit or scope of the general inventive concept as defined by the appended claims and their equivalents.

What is claimed is:

1. A still image memory device comprising:
an imaging unit that captures an image and outputs image data obtained by capturing the image;
a nonvolatile memory unit that includes a first memory area and a second memory area; and
a control unit that controls the nonvolatile memory unit, the control unit including
a first processing unit that stores, in the first memory area, the image data output from the imaging unit;
a second processing unit that, based on memory status of the first memory area, reads and compresses image data that is selected from a plurality of image data stored in the first memory area, stores compressed image data in the second memory area, and destroys the image data that is selected from the plurality of image data stored in the first memory area; and
a third processing unit that, based on memory status of the second memory area, destroys compressed image data that is selected from a plurality of compressed image data stored in the second memory area.

2. The still image memory device according to claim 1, wherein the first processing unit includes
a first determining unit that compares image data that is captured most recently by the imaging unit and image data that is captured previously by the imaging unit, and determines whether a comparative difference therebetween is equal to or more than a predetermined amount; and
a first administrating unit that stores image data output from the imaging unit in the first memory area if the first determining unit determines that the comparative difference between the image data that is captured most recently by the imaging unit and the image data that is captured previously by the imaging unit is equal to or more than the predetermined amount.

3. The still image memory device according to claim 2, wherein
the first processing unit further includes a data generating unit that generates data that is used as an index while searching image data captured by the imaging unit, and
the first administrating unit stores, in the first memory area, the data generated by the data generating unit in an attached manner to image data output from the imaging unit.

4. The still image memory device according to claim 2, wherein the comparative difference is calculated based on either one of a YUV component value and a RGB component value of each pixel of the image data that is captured most recently and the image data that is captured previously.

5. The still image memory device according to claim 2, wherein the comparative difference is obtained by comparing a difference between values of two different pixels of the image data that is captured most recently and of the image data that is captured previously.

6. The still image memory device according to claim 3, wherein the data used as the index is an average value of either one of YUV component values and RGB component values across entire image data.

7. The still image memory device according to claim 3, wherein the data used as the index is the comparative difference.

8. The still image memory device according to claim 3, wherein the data used as the index is time information.

9. The still image memory device according to claim 1, further comprising
a first power supplying unit that, when power is supplied from a first power supply, converts and supplies a voltage from the first power supply to the imaging unit, the nonvolatile memory unit, and the control unit; and
a second power supplying unit that, when power is supplied from a second power supply, converts and supplies a voltage from the second power supply to the imaging unit, the nonvolatile memory unit, and the control unit.

10. The still image memory device according to claim 2, further comprising
a first power supplying unit that, when power is supplied from a first power supply, converts and supplies a voltage from the first power supply to the imaging unit, the nonvolatile memory unit, and the control unit; and
a second power supplying unit that, when power is supplied from a second power supply, converts and supplies a voltage from the second power supply to the imaging unit, the nonvolatile memory unit, and the control unit.

11. The still image memory device according to claim 3, further comprising
a first power supplying unit that, when power is supplied from a first power supply, converts and supplies a voltage from the first power supply to the imaging unit, the nonvolatile memory unit, and the control unit; and
a second power supplying unit that, when power is supplied from a second power supply, converts and supplies a voltage from the second power supply to the imaging unit, the nonvolatile memory unit, and the control unit.

12. A still image memory method comprising:
first-memory-area storing that includes storing, in a first memory area, image data obtained by capturing of an image;
compressing that includes reading, based on memory status of the first memory area, image data that is selected from a plurality of image data stored in the first memory area and compressing read image data;
second-memory-area storing that includes storing compressed image data in a second memory area;
first-memory-area destroying that includes destroying the image data that is selected from the plurality of image data stored in the first memory area; and
second-memory-area destroying that includes destroying, based on memory status of the second memory area, compressed image data that is selected from a plurality of compressed image data stored in the second memory area.

13. The still image memory method according to claim 12, wherein the first-memory-area storing includes
determining that includes comparing image data that is obtained most recently by capturing and image data that is obtained previously by capturing and determining whether a comparative difference therebetween is equal to or more than a predetermined amount, and
storing, in the first memory area, image data obtained by capturing if it is determined at the determining that the comparative difference between the image data that is obtained most recently by capturing and the image data that is obtained previously by capturing is equal to or more than the predetermined amount.

14. The still image memory method according to claim 13, wherein
the first-memory-area storing further includes generating data that is used as an index while searching the image data obtained by capturing, and
storing, in the first memory area, the data generated at the generating in an attached manner to the image data obtained by capturing.

15. The still image memory method according to claim 13, wherein the comparative difference is calculated based on either one of a YUV component value and a RGB component value of each pixel of the image data that is obtained most recently by capturing and the image data that is obtained previously by capturing.

16. The still image memory method according to claim 13, wherein the comparative difference is obtained by comparing a difference between values of two different pixels of the image data that is obtained most recently by capturing and of the image data that is obtained previously by capturing.

17. The still image memory device according to claim 14, wherein the data used as the index is an average value of either one of YUV component values and RGB component values across entire image data.

18. The still image memory device according to claim 14, wherein the data used as the index is time information.

19. A lighting apparatus comprising:
a still image memory device that includes
an imaging unit that captures an image and outputs image data obtained by capturing the image;
a nonvolatile memory unit that includes a first memory area and a second memory area;
a control unit that controls the nonvolatile memory unit; and
a power supplying unit that converts and supplies a supplied power-supply voltage to the imaging unit, the nonvolatile memory unit, and the control unit;
a light emitting unit that emits light using a supplied electric power; and
a voltage converting unit that converts and supplies an input voltage to the power supplying unit in the still image memory device and the light emitting unit, wherein
an imaging range of the imaging unit at least partially includes an area being irradiated by the light emitted from the light emitting unit.

20. The lighting apparatus according to claim 19, wherein the light emitting unit is an LED.
